(19) United States
(12) Patent Application Publication
(10) Pub. No.: US 2012/0206722 A1
(43) Pub. Date: Aug. 16, 2012

(54) High-Resolution Laser Induced Breakdown Spectroscopy Devices and Methods

(76) Inventors: Costas P. Grigoropoulos, Berkeley, CA (US); David Jen Hwang, Albany, CA (US); Jong Hyun Yoo, Milpitas, CA (US); Richard E. Russo, Walnut Creek, CA (US)

(21) Appl. No.: 13/155,207

(22) Filed: Jun. 7, 2011

Related U.S. Application Data
(63) Continuation of application No. PCT/US2009/068860, filed on Dec. 18, 2009.
(60) Provisional application No. 61/138,869, filed on Dec. 18, 2008.

(51) Int. Cl. G01J 3/30

(52) U.S. Cl. 356/318

(57) ABSTRACT

Provided are laser induced breakdown spectroscopy (LIBS) devices. Embodiments of the devices are configured to obtain a spatial resolution of 10 μm or less. Also provided are methods of using the subject LIBS devices to determine whether one or more elements of interest are present in a target sample. The devices and methods find use in a variety of applications, e.g., submicron and nanoscale chemical analysis applications.

### CROSS-REFERENCE TO RELATED APPLICATION

Pursuant to 35 U.S.C. §119(e), this application claims priority to the filing date of U.S. Provisional Patent Application Ser. No. 61/138,869, filed Dec. 18, 2008, which application is incorporated herein by reference in its entirety.

### REFERENCE TO GOVERNMENT SUPPORT

This invention was made with government support under Grant Number 20053027 awarded by the Army Small Business Technology Transfer Program (STTR) (Phases I and II). The government has certain rights in the invention.

### INTRODUCTION

Optical emission can be utilized as a processing, monitoring and/or sample analysis tool. Laser induced breakdown spectroscopy (LIBS) is a type of atomic emission spectroscopy that uses a laser as the excitation source. LIBS operates by focusing the laser onto an area on the surface of a target sample. When the laser is discharged it ablates a small amount of material and creates an ablation site and a plasma plume. The ablated material dissociates (i.e., breaks down) into excited ionic and atomic species. During this time, the plasma emits a continuum of radiation, and the plasma expands and cools. The characteristic atomic emission lines of the elements in the plasma can be observed. LIBS is also referred to by its alternative name: laser-induced plasma spectroscopy (LIPS).

The spatial resolution of LIBS devices depends on various factors, such as the size of the ablation site, the thermal absorption properties of the target sample, and the precision in movement of the target sample stage. In addition, the size of the ablation site created by the laser depends on factors, such as the pulse energy of the laser, the fluence (e.g., energy per unit area) of the laser, and the pulse width of the laser. As the size of the ablation sites decreases, the theoretically achievable spatial resolution increases. However, an additional consideration for LIBS devices is that as the size of the ablation site decreases, less plasma is created, which makes detecting emission signals from the plasma more difficult. The reduced amount of plasma also leads to a lower signal-to-noise ratio for the detected emission signals. Due to the above considerations, a typical LIBS device produces ablation sites having average diameters of tens to hundreds of micrometers, and correspondingly has a spatial resolution of tens to hundreds of micrometers.

### SUMMARY

Provided are laser induced breakdown spectroscopy (LIBS) devices. Embodiments of the devices are configured to obtain a spatial resolution of 10 μm or less. Also provided are methods of using the subject LIBS devices to determine whether one or more elements of interest are present in a target sample. The devices and methods find use in a variety of applications, e.g., submicron and nanoscale chemical analysis applications.

### BRIEF DESCRIPTION OF THE FIGURES

FIG. 1(a) shows a schematic diagram of an objective lens based laser induced breakdown spectroscopy (LIBS) device using a nanosecond laser according to embodiments of the invention. FIG. 1(b) shows a schematic diagram of an optical near-field based LIBS device using a nanosecond laser according to embodiments of the invention. FIG. 1(c) shows a schematic diagram of an objective lens based femtosecond LIBS device according to embodiments of the invention.

FIG. 2 shows graphs of ablation craters and atomic force microscopy (AFM) images of ablation craters by single femtosecond laser pulses under various coupled pulse energy conditions according to embodiments of the invention. Measured output pulse energy and estimated fluence are indicated.

FIG. 3 shows side-view emission imaging (right side of each fluence case) and measured spectrum (left side of each fluence case) during the femtosecond laser ablation for the ablation craters shown in FIG. 2 according to embodiments of the invention. Gate width of 1 ms was used to measure for the entire lifetime.

FIG. 4 shows time-resolved emission imaging (right side of each fluence case) and time-resolved spectrum measurement (left side of each fluence case) with 2 ns gate width for 98 nJ pulse energy (5.55 J/cm²) using a femtosecond laser according to embodiments of the invention. Delay time is shown in each time step.

FIG. 5 shows graphs of ablation craters and AFM scanning images of ablation craters from an optical near-field fiber probe and single nanosecond laser pulses of 532 nm wavelength under various coupled pulse energy conditions according to embodiments of the invention. Measured output pulse energy is indicated in the figure.

FIGS. 6(a) and 6(b) show side-view emission imaging of the optical near-field based ablation process shown in FIG. 5 according to embodiments of the invention. FIG. 6(a) shows the entire lifetime (10 μs) measurement for various pulse energies according to embodiments of the invention. Measured output pulse energy is indicated in the figure. FIG. 6(b) shows time-resolved imaging with 2 ns exposure time for the 522 nJ pulse energy case according to embodiments of the invention. Delay time is indicated in each time step. Time-zero corresponds to the peak intensity timing of the temporally Gaussian-shaped nanosecond laser pulse. Material ejection continued for 10 μs after this timing, showing the jet-like material expulsion trajectories.

FIG. 7(a) shows measured spectra in an optical near-field ablation process for several pulse energies, as indicated in the figure, for the entire lifetime (10 μs) according to embodiments of the invention. FIG. 7(b) shows the corresponding measured AFM graphs of ablation craters according to embodiments of the invention. Single nanosecond laser pulses of 532 nm wavelength under various coupled pulse energy conditions, as indicated in the figures, were used for the experiments shown in FIGS. 7(a) and 7(b).

FIG. 8 shows measured time-resolved spectra for an optical near-field ablation with 2 ns exposure time for the 195 nJ pulse energy case shown in FIGS. 7(a) and 7(b) according to embodiments of the invention. Collected emissions signals for the entire lifetime was compared on the same data scale.

### DETAILED DESCRIPTION

Provided are laser induced breakdown spectroscopy (LIBS) devices. Embodiments of the devices are configured to obtain a spatial resolution of 10 μm or less. Also provided are methods of using the subject LIBS devices to determine whether one or more elements of interest are present in a target sample. The devices and methods find use in a variety of applications, e.g., submicron and nanoscale chemical analysis applications.

Below, the subject laser induced breakdown spectroscopy (LIBS) devices are described first in greater detail. In addition, methods of detecting whether an element is present in a target sample are disclosed in which the subject devices find use.

### Laser Induced Breakdown Spectroscopy Devices

Devices are disclosed that provide for laser induced breakdown spectroscopy. In certain embodiments, the devices are configured to obtain a spatial resolution of 10 μm or less. As used herein, the term “spatial resolution” refers to the lateral distance between ablation sites on a surface of a target sample and is a measure of how close ablation sites can be produced on a surface of a target sample without substantially interfering with the LIBS detection from each ablation site. Spatial resolution is measured as the distance from the center of one ablation site to the center of an adjacent ablation site. A device characterized as having a high spatial resolution indicates that a greater number of ablation sites per unit area can be produced. A device characterized as having a low spatial resolution indicates that fewer ablation sites per unit area can be produced. In certain embodiments, the device is configured to obtain a spatial resolution of 10 μm or less, such as 7 μm or less, including 5 μm or less, 3 μm or less, 1.5 μm or less, 1 μm or less, 0.8 μm or less, 0.7 μm or less, 0.5 μm or less, 0.3 μm or less, 0.1 μm or less, 0.05 μm or less, or 0.01 μm or less. For example, the devices may be configured to obtain a spatial resolution ranging from 0.01 μm to 10 μm, such as from 0.05 μm to 7 μm, including from 0.1 μm to 5 μm, for example from 0.1 μm to 3 μm, such as from 0.5 μm to 1.5 μm.

In certain embodiments, the device includes an ablator. As used herein, the term “ablator” refers to a device that is configured to remove (ablate) material from the surface of a target sample. In some cases, the ablator is configured to remove material from the surface of the target sample by vaporizing material on the surface of the target sample. When the ablator vaporizes material on the surface of the target sample, the ablator may produce an ablation site and a plasma.

An ablation site is an area on the surface of the target sample where material was removed from the target sample by the ablator. In some instances, removal of material from the surface of the target sample produces an ablation site that appears as a crater in the surface of the target sample. In certain embodiments, the ablator is configured to produce an ablation site having an average diameter of 10 μm or less, such as 7 μm or less, including 5 μm or less, 3 μm or less, 1.5 μm or less, 1 μm or less, 0.8 μm or less, 0.7 μm or less, 0.5 μm or less, 0.3 μm or less, 0.1 μm or less, 0.05 μm or less, or 0.01 μm or less. For example, the ablator may be configured to produce an ablation site having an average diameter ranging from 0.01 μm to 10 μm, such as from 0.05 μm to 7 μm, including from 0.1 μm to 5 μm, for example from 0.1 μm to 3 μm, such as from 0.5 μm to 1.5 μm. In certain embodiments, the ablator is configured to produce an ablation site having a depth ranging from 1 nm to 1000 nm, such as from 10 nm to 500 nm, including from 100 nm to 300 nm. In some cases, the ablator is configured to produce an ablation site having a depth of 200 nm.

As used herein, the term “plasma” refers to a gas that includes excited ions and electrons. A plasma may be an artificially-produced plasma and may be produced by contacting energy with a material. For example, the plasma may be a laser-produced plasma, which is produced when a laser of sufficient energy contacts an appropriate material. In some instances, a plasma is produced when the ablator ablates material on the surface of the target sample. In certain cases, the plasma includes excited ionic and atomic species from the target sample and is representative of the composition of the target sample. Since atomic emission lines are directly related to the structure of the ablated material, spectroscopic analysis of detected emissions from the plasma can be used for chemical composition analysis of the ablated material.

In certain embodiments, the ablator includes an electromagnetic radiation source. An electromagnetic radiation source is a device that is configured to emit electromagnetic radiation. The ablator may include an electromagnetic radiation source that is a laser source configured to emit a laser beam. In some cases, the electromagnetic radiation source is a visible spectrum laser source configured to emit a visible spectrum laser beam. In other cases, the electromagnetic radiation source is an ultraviolet (UV) laser source configured to emit a UV laser beam. The electromagnetic radiation source may be configured to emit electromagnetic radiation that has a wavelength ranging from 380 nm to 800 nm. In certain instances, the electromagnetic radiation source is configured to emit electromagnetic radiation that has a wavelength ranging from 10 nm to 380 nm. In some cases, the electromagnetic radiation source that is configured to emit electromagnetic radiation that has a wavelength ranging from 0.001 nm to 10 nm.

In some cases, the ablator is configured to contact the target sample with a laser beam at a desired illumination angle with respect to the target surface. For example, the ablator may be configured to contact the surface of the target sample with a laser beam where the angle between the surface of the target sample and the laser beam ranges from 0 degrees to 90 degrees, such as 30 degrees, or 45 degrees, or 60 degrees. In certain embodiments, the ablator is configured to contact the surface of the target sample with a laser beam where the laser beam is substantially normal to the surface of the target sample.

Certain embodiments of the ablator include a laser configured to have a short pulse width. Lasers that have a short pulse width may be configured to have a high repetition rate, such that a plurality of laser pulses may be emitted within a given amount of time. In some cases, the laser is configured to have a repetition rate ranging from 1 kHz to 1000 MHz, such as from 10 kHz to 500 MHz, including from 10 kHz to 100 MHz, for example from 50 kHz to 10 MHz. A laser having a short pulse width may facilitate an improvement in the signal-to-noise ratio for the device. For example, in some instances, the laser has a short pulse width, such as a pulse width that is shorter than the time it takes for the plasma to form at the ablation site after the laser beam contacts the target sample. In these cases, the laser beam, such as the trailing portion of the laser beam, may have a reduced time to interact with the plasma. In addition, the plasma may expand and disperse in three-dimensions away from the ablation site. As the plasma expands in three-dimensions away from the ablation site, this may also facilitate a reduction in the interaction of the laser beam with the plasma. In certain embodiments, a reduction in the interaction of the laser beam with the plasma facilitates a reduction in wide spectrum background noise in the detected emissions signals and thus facilitates an increase in the signal-to-noise ratio.

In certain embodiments, the laser may be a nanosecond laser having a pulse width on the order of nanoseconds. The nanosecond laser may have a pulse width ranging from 1 ns to 1000 ns, or from 1 ns to 500 ns, or from 1 ns to 100 ns, or from 1 ns to 50 ns, or from 1 ns to 20 ns, such as from 1 ns to 10 ns, including from 2 ns to 8 ns, for example from 4 ns to 6 ns. In certain instances, the nanosecond laser is a Q-switched Nd:YAG laser.

In certain embodiments, the nanosecond laser has a focal spot diameter ranging from 0.1 μm to 50 μm, such as from 1 μm to 25 μm, including from 1 μm to 10 μm. The focal spot diameter is the diameter of the laser at its focal spot. The focal spot of a laser is the spot where the laser beam has the highest concentrated energy. The focal spot diameter of the laser is approximately the optical diffraction limit (i.e., half the wavelength of the coupled light). In some instances, the nanosecond laser has a focal spot diameter of 7 μm. In some cases, the nanosecond laser has a focal spot diameter of 1.5 μm.

In embodiments where the nanosecond laser has a focal spot diameter of 7 μm, the nanosecond laser may have a pulse energy ranging from 10 nJ to 1000 nJ, such as from 100 nJ to 900 nJ, including from 300 nJ to 800 nJ. In some embodiments, the nanosecond laser has a fluence ranging from 0.1 J/cm² to 10 J/cm², such as from 0.1 J/cm² to 5 J/cm², including from 0.5 J/cm² to 2 J/cm². As used herein, the term “fluence” refers to the energy per unit area of a laser.

In embodiments where the nanosecond laser has a focal spot diameter of 1.5 μm, the nanosecond laser may have a pulse energy ranging from 1 nJ to 500 nJ, such as from 10 nJ to 100 nJ, including from 20 nJ to 80 nJ. In some embodiments, the nanosecond laser has a fluence ranging from 0.1 J/cm² to 50 J/cm², such as from 0.5 J/cm² to 10 J/cm², including from 1 J/cm² to 5 J/cm².

Further aspects of the ablator include embodiments where ablator includes a femtosecond laser having a pulse width on the order of femtoseconds. In some embodiments, the femtosecond laser has a pulse width ranging from 1 femtosecond (fs) to 1000 fs, such as from 10 fs to 500 fs, including from 10 fs to 150 fs, for example, from 10 fs to 100 fs. In some cases, the femtosecond laser has a pulse energy ranging from 1 nJ to 500 nJ, such as from 10 nJ to 200 nJ, including from 20 nJ to 150 nJ, such as from 20 nJ to 130 nJ, for example from 25 nJ to 100 nJ. In some embodiments, the femtosecond laser has a fluence ranging from 0.5 J/cm² to 10 J/cm², such as from 1 J/cm² to 8 J/cm², including from 1.5 J/cm² to 6 J/cm². The femtosecond laser may be a frequency doubled Ti:Al₂O₃ laser.

In some cases, the device includes a laser source configured to generate a first laser pulse and a second laser pulse. As described above, the first laser pulse is configured to contact the target sample and produce an ablation site and a plasma. In some instances, the second laser pulse is configured to contact the plasma created by the first laser pulse. The second laser pulse may facilitate an increase in the plasma strength and emission, thus facilitating detection of the emission spectra and may increase the signal-to-noise ratio. In some cases, the laser source is configured to discharge the second laser pulse immediately after discharging the first laser pulse. For example, the laser source may be configured to discharge the second laser pulse in 1000 ns or less following the first laser pulse, such as 500 ns or less, including 250 ns or less, or 100 ns or less, or 50 ns or less, or 25 ns or less, or 10 ns or less, or 5 ns or less, or 1 ns or less following the first laser pulse.

In certain embodiments, the device includes a first laser source configured to generate a first laser beam and a second laser source configured to generate a second laser beam. The second laser beam may be directed from the second laser source to the target sample at the ablation site. In some cases, the second laser beam is coupled to the same optical system as the first laser source, such that the first laser and the second laser both pass through the same optical system. In other embodiments, the device includes separate optical systems for the first and second laser beams, respectively. In these embodiments, the second laser beam may be directed to the target at an angle to the first laser beam. The angle between the first laser beam and the second laser beam may range from 0 degrees to 90 degrees, such as 30 degrees, including 45 degrees, for example 60 degrees, or 90 degrees. In some cases, the second laser beam is substantially perpendicular to the first laser beam.

In certain embodiments, the second laser beam is discharged by the second laser source at substantially the same time that the first laser beam is discharged by the first laser source. In some cases, the first laser beam is discharged by the first laser source immediately after the second laser beam is discharged by the second laser source. In other cases, the first laser beam is discharged by the first laser source immediately before the second laser beam is discharged by the second laser source. In some embodiments, the second laser is configured to reach the ablation site immediately after the first laser beam contacts the target sample. As described above, when the first laser beam contacts the target sample, an ablation site and a plasma are produced. In some instances, the second laser beam is configured to contact the plasma created by the first laser beam. For example, the second laser beam may be configured to contact the plasma in 1000 ns or less following the first laser beam, such as 500 ns or less, including 250 ns or less, or 100 ns or less, or 50 ns or less, or 25 ns or less, or 10 ns or less, or 5 ns or less, or 1 ns or less following the first laser beam. The second laser beam may facilitate an increase in the plasma strength and emission, thus facilitating detection of the emission spectra.

In certain embodiments, the ablator includes an optical system configured to direct the electromagnetic radiation from the electromagnetic radiation source to the surface of the target sample. For example, the optical system may be configured to direct a laser beam from a laser source to a surface of a target sample. In some cases, the optical system is configured to direct the laser beam from the laser source to the surface of the target sample at an angle substantially normal to the surface of the target sample. For instance, the optical system may be configured to direct the laser beam from the laser source to the target sample at an angle acute to the surface of the target sample, such as from 0 degrees to 90 degrees, for example 30 degrees, or 45 degrees, or in some cases, 60 degrees.

In some cases, the optical system includes far-field optics. For example, the optical system may include a lens. The lens may be an objective lens used to focus the electromagnetic radiation emitted from the electromagnetic radiation source onto the surface of the target sample. As used herein, the terms “far-field” and “far-field optics” refer to devices that include an objective lens to focus the electromagnetic radiation emitted from the electromagnetic radiation source onto the surface of the target sample. As described above, the focal spot diameter of a laser is approximately the optical diffraction limit (i.e., half the wavelength of the coupled light). In some embodiments, the far-field optics facilitate focusing the laser beam to produce focal spots having diameters less than the diffraction limit. In some cases, the ablator includes a high numerical aperture (NA) lens. The lens may have a numerical aperture ranging from 0.1 to 1, such as from 0.1 to 0.7, including from 0.1 to 0.5, or from 0.1 to 0.3. For example, the lens may have a numerical aperture of 0.14. Embodiments of the ablator that include a lens having a numerical aperture of 0.14 may be configured to produce a nanosecond laser beam having a focal spot diameter of 7 μm. In some cases the lens has a numerical aperture of 0.7. Embodiments of the ablator that include a lens having a numerical aperture of 0.7 may be configured to produce a nanosecond laser beam having a focal spot diameter of 1.5 μm.

In certain embodiments, the lens may have a numerical aperture ranging from 0.1 to 1, such as from 0.2 to 0.8, including from 0.3 to 0.7, or from 0.5 to 0.6. For example, the lens may have a numerical aperture of 0.55. Embodiments of the ablator that include a lens having a numerical aperture of 0.55 may be configured to produce a femtosecond laser beam having a focal spot diameter of 1.5 μm.

In certain embodiments, the optical system includes near-field optics. For example, the optical system may include an optical probe. The optical probe may be configured to direct the electromagnetic radiation emitted from the electromagnetic radiation source to the surface of the target sample. As used herein, the terms “near-field” and “near-field optics” refer to devices that include an optical probe to direct the electromagnetic radiation emitted from the electromagnetic radiation source onto the surface of the target sample. For instance, a laser may be coupled to the end of the optical probe distal to the target sample and directed through the optical probe towards the target sample. The laser beam may be emitted from the end of the optical probe proximal to the target sample and contact the surface of the target. When light is irradiated onto an aperture whose diameter is smaller than the wavelength, the emerging radiation diverges due to diffraction. In some instances, the laser emitted from the proximal end of the optical probe diverges due to diffraction as described above. In certain embodiments, the proximal end of the optical probe is positioned at a distance from the surface of the target sample such that the laser emitted from the proximal end of the optical probe contacts the surface of the target sample before the laser substantially diffracts. For example, the proximal end of the optical probe may be positioned at a distance from the surface of the target ranging from 1 nm to 1000 nm, such as from 1 nm to 500 nm, including from 1 nm to 250 nm, or 1 nm to 100 nm, or 1 nm to 50 nm, or 1 nm to 25 nm, for example 1 nm to 10 nm. In certain embodiments, the tip of the proximal end of the optical probe is positioned at a distance of 10 nm from the surface of the target. In some cases, the distance between the proximal end of the optical probe and the surface of the target sample is controlled by scanning probe microscopy (SPM) systems, such as atomic force microscopy (AFM) systems.

The optical probe may be an optical illumination probe, such as an optical fiber probe. In some cases, the optical fiber probe is a hollow optical fiber probe. In other cases, the optical fiber probe is a solid optical fiber probe (i.e., not hollow). In certain embodiments, the optical probe is a near-field scanning optical microscopy (NSOM) probe, such as but not limited to an apertureless NSOM probe, an apertured NSOM probe, a cantilevered NSOM probe, a micromachined cantilevered NSOM probe, a straight tapered NSOM probe, an etched NSOM probe, and the like. In some instances, the optical probe is an apertureless NSOM probe.

In certain embodiments, the optical probe is modified to give higher efficiency and throughput. For example, the optical probe may be etched. In certain cases, the optical probe is etched by chemical etching. In certain embodiments, the optical probe has a coating disposed on at least a portion of the outer surface of the optical probe. The coating may be on substantially the whole optical probe, such that the optical probe is an apertureless optical probe. The proximal end of the optical probe may be tapered to a tip. In some instances, the coating is disposed on the surface of the optical probe near the tip of the optical probe. In other embodiments, the coating is disposed on the surface of the optical probe except near the tip of the optical probe, such that the optical probe has an aperture in the coating at the tip of the optical probe. In some cases, the aperture has a diameter of 1 nm to 5000 nm, such as 10 nm to 2500 nm, including 10 nm to 1000 nm, or 10 nm to 500 nm, for example 10 nm to 250 nm, or 10 nm to 100 nm.

In certain embodiments, the subject LIBS device includes a detector. The detector may be configured to detect emissions from the plasma produced at the surface of the target sample by the ablator. For example, the detector may be configured to detect atomic emission spectra from the plasma. In certain instances, the detector may include a charge-coupled device (CCD). In some cases, the CCD is an intensified CCD (ICCD). In certain cases, the detector further includes collection optics configured to direct emissions from the plasma to the detector. The collection optics may include reflective and/or semi-reflective collection optics, such as, but not limited to, a mirror (M), a beam splitter (BS), a polarizing beam splitter (PBS), and the like.

In certain embodiments, the detector includes far-field collection optics. The far-field collection optics may include a lens, such as a collecting objective lens. As used herein, the term “collecting objective lens” refers to a lens that uses collection optics to focus light. In certain cases, the collecting objective lens may be used for detecting narrow-band LIBS emissions. In some cases, the detector includes a reflective objective lens. As used herein, the term “reflective objective lens” refers to a lens that uses reflective optics to focus light. For example, in some instances, a reflective objective lens may be used for detecting broad-band LIBS emissions. In certain embodiments, the collecting objective lens may be a high numerical aperture lens. In some cases, the collecting objective lens is the same type of lens as the objective lens used to focus the laser from the laser source onto the surface of the target, as discussed above.

In certain embodiments, the detector can include a transmissive objective lens. As used herein, the term “transmissive objective lens” refers to a lens that focuses light as the light passes through the lens. In some cases, narrow-band LIBS devices include a transmissive objective lens. As used herein, the term “narrow-band” refers to LIBS devices that detect emissions over small spectral intervals. In certain embodiments, the detector includes a reflective objective lens. As used herein, the term “reflective objective lens” refers to a lens that focuses light by reflecting light off of one or more surfaces of the lens. In some cases, wide-band LIBS devices include a reflective objective lens. As used herein, the term “wide-band” refers to LIBS devices that detect emissions over large spectral intervals. The reflective objective lens may facilitate a reduction in chromatic aberrations.

In certain embodiments, the detector includes a near-field collection probe. The near-field collection probe may be an optical fiber probe. In some cases, the near-field collection probe is a solid optical fiber probe (i.e., not hollow). In other cases, the near-field collection probe is a hollow optical fiber probe. In some instances, the near-field collection probe is configured to collect emissions from a near-field LIBS device that includes a near-field illumination probe as described above. In certain embodiments, the near-field illumination probe is a solid (i.e., non-hollow) optical probe. The plasma produced when the laser contacts the target may expand outward from the gap between the tip of the optical probe and the ablation site. As described in more detail below, the detector may be configured to detect LIBS emissions at an angle to the laser when the laser contacts the surface of the target. This may facilitate more efficient collection of emissions and improve the detected signal strength and signal-to-noise ratio. In some embodiments, the near-field collection probe is a hollow near-field optical probe. The laser-induced plasma may expand and pass through the aperture in the hollow probe. This may facilitate collection of LIBS emissions substantially normal to the target.

In certain embodiments, the detector includes one collection probe. In some instances, the detector includes a plurality of collection probes, such as 2 or more collection probes, 3 or more, 4 or more, 5 or more, 6 or more, 7 or more, 8 or more, 9 or more, 10 or more, 15 or more, 20 or more, 30 or more, 40 or more, 50 or more, 60 or more, 70 or more, 80 or more, 90 or more, or 100 or more collection probes. In some cases, the plurality of collection probes is arranged in one or more bundles of collection probes. The collection probe can be positioned in close proximity to the ablation site. In embodiments that use near-field illumination optics as described above, collection probe can be positioned in close proximity to the near-field illumination probe. For example, the collection probe can be positioned from 1 nm to 1000 nm from the near-field illumination probe, such as from 1 nm to 500 nm, including from 1 nm to 250 nm, or from 1 nm to 100 nm, for instance from 1 nm to 50 nm from the near-field illumination probe. In certain cases, positioning the collection probe in close proximity to the near-field illumination probe facilitates efficient collection of LIBS emissions and improves the detected signal strength and signal-to-noise ratio.

In addition, in some cases, the collected LIBS signal can be collimated using a finite-infinite-conjugated objective lens. The collimated LIBS signal may then be re-focused into the collection probe using a transmissive lens as described above. The lens may be directly coupled to a collection probe. In certain embodiments, the detector includes a finite-finite-conjugated lens. In some cases, a negative mirror type lens is used for re-focusing the collected LIBS emissions onto the collection probe.

In certain embodiments, the detector includes a flipping mirror positioned after the collecting objective lens. A flipping mirror is a mirror configured to switch the observed view between two different signals by changing the position of the flipping mirror. For example, the flipping mirror may be configured to reflect away the LIBS signal with the laser ablation spot image, which facilitates monitoring of the laser focal spot for field-of-view alignment of the collecting objective lens. In some cases, the detector further includes a laser blocking filter positioned after the collecting objective lens. The laser blocking filter may be configured to block the portion of the detected signal that corresponds to the emissions from the laser. The laser blocking filter may facilitate a reduction in the detected signal due to the laser, and thus may improve the signal-to-noise ratio of the detected emission spectra.

In certain instances, the detector is configured to detect emissions at a desired detection angle relative to the surface of the target sample. For example, in some cases, the laser beam is substantially normal to the surface of the target when the laser beam contacts the surface of the target. The detection angle may range from 0 degrees to 90 degrees with respect to the laser, such as 30 degrees, or 45 degrees, or 60 degrees, or 90 degrees. In certain embodiments, the detector is configured to detect emissions substantially parallel to the surface of the target sample. In some embodiments, the detector is configured to detect emissions substantially normal to the surface of the target sample.

In certain embodiments, the detector includes a signal splitter configured to input a signal and output two or more substantially identical signals. In some cases, the detector includes a filter, such as a band pass filter, a monochromator, and the like. The signal splitter and the filter may facilitate multi-element mapping from a single input signal. For example, an input signal may be split into several signals and specific emission peaks corresponding to specific atomic transition lines of an element may be selected through a band pass filter for each signal. The emission intensity for each ablation site may be measured by the detector.

In addition, typical LIBS devices include a detector that has a signal enhancer, such as a signal enhancer that performs time-gating of the emission signal. As used herein, the terms “time gate” and “time gating” refer to enhancing detected signals by ignoring emission signals at times when the signal-to-background ratio is insufficient to detect acceptable signals and detecting emission signals at times when the signal-to-background ratio is sufficient to detect acceptable signals. For example, typical LIBS devices may include a signal enhancer, such as a photomultiplier output current time gate, a gated intensifier, a streak camera, and the like. In certain embodiments, the subject LIBS device has a sufficient signal-to-noise ratio such that a signal enhancer is not necessary. Thus, in some cases, the subject devices do not include a signal enhancer. In certain instances, the subject devices do not include a time gate.

In certain embodiments, the LIBS device includes a target sample stage configured to support a target sample. The device may be configured to change the position of the target sample with respect to the position of the laser beam. For example, the device may be configured to change the position of the target sample while the positions of the laser and the detector remain substantially the same with respect to each other. In some cases, the target sample stage may include a scanning motion apparatus configured to change the position of the target sample as desired. The scanning motion apparatus can include a motorized micro/nano stage, a piezo scanner, and the like. The device may further include control software and/or control hardware configured to synchronize the scanning motion, laser triggering, and emission detection, for each ablation site. The device may further include an auto-focuser configured to automatically focus the laser beam on the surface of the target sample. In some cases, the auto-focuser facilitates maintaining stable ablation at high spatial resolution.

In certain embodiments, the device may be configured to change the position of the laser relative to the target sample. In certain far-field embodiments, the device is configured to change the position and/or angle of the objective lens such that the laser beam contacts the target sample at a different position for successive ablations. In certain near-field embodiments, the device is configured to change the position of the optical probe relative to the target sample such that the laser beam contacts the target sample at a different position for successive ablations. In addition, the detector may be configured to change position in coordination with the laser as the laser changes position. For example, in embodiments that include a near-field collection probe, the near-field collection probe may be configured to change position when the laser changes position, such that the relative positions of the laser and the near-field collection probe with respect to each other remain substantially the same.

As described above, the subject device may be configured to perform elemental analysis of a target sample. In some cases, the subject device is configured to have a size and weight such that the device is portable. By portable is meant that the device is easily transported from a first location to a second location. For example, the device may be configured to have a size approximating the size of a suitcase, briefcase, and the like. Portable LIBS devices may be configured to perform elemental analysis of target samples in situ without the need to transport the target sample to a location where there is an installed LIBS device. A portable LIBS device may facilitate the analysis of target samples that are too large or delicate to be readily transported.

In certain embodiments, the subject LIBS device can be used as part of a detection system. In some cases, the detection system can include one or more detection devices, such as but not limited to: a LIBS device; a mass spectrometer; a Raman spectrometer; a fluorescence spectrometer; a laser induced fluorescence spectrometer; an x-ray fluorescence spectrometer; a scanning probe microscope, such as but not limited to a near-field scanning optical microscope (NSOM), an atomic force microscope (AFM), etc.; an electron microscope, such as but not limited to a scanning electron microscope; and the like. In some cases, the one or more detection devices can be included in a single instrument.

### Far-Field LIBS

In certain embodiments, far-field LIBS devices as described above include an ablator, and a detector. As reviewed above, “far-field” refers to devices that include an objective lens to focus the electromagnetic radiation emitted from the electromagnetic radiation source onto the surface of the target sample. In some cases, the ablator includes a laser source and a lens. The laser source may be a nanosecond laser. In embodiments of devices that include a nanosecond laser, the lens may have a numerical aperture ranging from 0.1 to 1, such as from 0.1 to 0.7, including from 0.1 to 0.5, or from 0.1 to 0.3. For example, the lens may have a numerical aperture of 0.14. When the nanosecond laser has a numerical aperture of 0.14, the nanosecond laser may have a focal spot diameter of 7 μm. In embodiments where the nanosecond laser has a focal spot diameter of 7 μm, the nanosecond laser may have a pulse energy ranging from 10 nJ to 1000 nJ, such as from 100 nJ to 900 nJ, including from 300 nJ to 800 nJ. In addition, in some embodiments, the nanosecond laser has a fluence ranging from 0.1 J/cm² to 10 J/cm², such as from 0.1 J/cm² to 5 J/cm², including from 0.5 J/cm² to 2 J/cm². In these embodiments, the ablation site produced by the nanosecond laser has an average diameter ranging from 0.1 μm to 10 μm, such as from 1 μm to 10 μm, including from 3 μm to 10 μm, for example, 5 μm to 10 μm.

In certain embodiments of devices that include a nanosecond laser, the lens may have a numerical aperture of 0.7. When the nanosecond laser has a numerical aperture of 0.7, the nanosecond laser may have a focal spot diameter of 1.5 μm. In embodiments where the nanosecond laser has a focal spot diameter of 1.5 μm, the nanosecond laser may have a pulse energy ranging from 1 nJ to 500 nJ, such as from 10 nJ to 100 nJ, including from 20 nJ to 80 nJ. In some embodiments, the nanosecond laser has a fluence ranging from 0.1 J/cm² to 50 J/cm², such as from 0.5 J/cm² to 10 J/cm², including from 1 J/cm² to 5 J/cm². In these embodiments, the ablation site produced by the nanosecond laser has an average diameter ranging from 0.1 μm to 10 μm, such as from 0.5 μm to 7 μm, including from 1 μm to 5 μm, for example, 1 μm to 3 μm.

Alternatively, the laser source may be a femtosecond laser. In embodiments of devices that include a femtosecond laser, the lens may have a numerical aperture ranging from 0.1 to 1, such as from 0.2 to 0.8, including from 0.3 to 0.7, or from 0.5 to 0.6. For example, the lens may have a numerical aperture of 0.55. Embodiments of devices that include a femtosecond laser and a lens having a numerical aperture of 0.55 may be configured to produce a femtosecond laser beam having a focal spot diameter of 1.5 μm. In embodiments where the femtosecond laser has a focal spot diameter of 1.5 μm, the femtosecond laser may have a pulse energy ranging from 1 nJ to 500 nJ, such as from 10 nJ to 200 nJ, including from 20 nJ to 150 nJ, such as from 20 nJ to 130 nJ, for example from 25 nJ to 100 nJ. In some embodiments, the femtosecond laser has a fluence ranging from 0.5 J/cm² to 10 J/cm², such as from 1 J/cm² to 8 J/cm², including from 1.5 J/cm² to 6 J/cm². In these embodiments, the ablation site produced by the femtosecond laser has an average diameter ranging from 0.05 μm to 10 μm, such as from 0.05 μm to 5 μm, including from 0.05 μm to 3 μm, for example from 0.05 μm to 1 μm.

### Near-Field LIBS

In certain embodiments, near-field LIBS devices as described above include an ablator, and a detector. As reviewed above, “near-field” refers to devices that include an optical probe to direct the electromagnetic radiation emitted from the electromagnetic radiation source onto the surface of the target sample. In some cases, the ablator includes a laser source and an optical probe. The laser source may be a nanosecond laser. In some cases, the optical probe is an optical fiber probe. The optical fiber probe may have an aperture diameter of 300 nm. In certain instances, the optical fiber probe is coupled to a nanosecond laser source. The nanosecond laser may have a pulse width ranging from 20 ns to 1 ns, such as from 10 ns to 1 ns, including from 2 ns to 8 ns, for example from 4 ns to 6 ns. The nanosecond laser may have a pulse energy ranging from 10 nJ to 1000 nJ, such as from 50 nJ to 800 nJ, including from 100 nJ to 700 nJ, for example from 100 nJ to 600 nJ. In certain embodiments, the optical near-field device is configured to produce an ablation site on a target sample having an average diameter ranging from 0.1 μm to 10 μm, such as from 0.5 μm to 7 μm, including from 1 μm to 5 μm, for example, 1 μm to 3 μm.

### Methods

Provided are methods for determining whether an element is present in a target sample. For example, the method may include detecting the elemental composition of a target sample using a laser induced breakdown spectroscopy (LIBS) device, as described above. The atomic emission spectra of the target sample can be detected and compared to the atomic emission spectra of known elements to determine the presence or absence of elements in the target sample. In certain embodiments, the method includes detecting the atomic emission spectra of the target sample and comparing the detected atomic emission spectra to the atomic emission spectra of known biological specimens to determine whether an element is present in the target.

In certain embodiments, the method includes ablating a target sample with an ablator. As described above, the ablator may be configured to obtain a spectral resolution of 10 μm or less. In addition, the ablator may be configured to produce a plasma and an ablation site on a surface of the target sample. Aspects of the method also include evaluating the plasma to determine whether the element is present in the target sample. In some cases, the method is implemented by a laser induced breakdown spectroscopy (LIBS) device, as described herein. In certain embodiments, the result of the evaluating step is displayed or communicated to a user in a user readable format.

The ablating may include generating electromagnetic radiation as an electromagnetic radiation source. In some cases, the ablating includes directing the electromagnetic radiation towards a surface of a target sample such that the electromagnetic radiation contacts the target sample to produce a plasma and an ablation site. For example, the ablating may include directing a laser beam from a laser source towards a surface of a target such that the laser beam contacts the target sample to produce a plasma and an ablation site on the target sample. As described above, the laser source may be a nanosecond laser, a femtosecond laser, and the like.

The directing may be performed by far-field or near-field optical systems as described above. In certain embodiments of far-field devices, the directing includes passing the laser beam through a lens as described above. For example, the method associated with far-field devices may include passing the electromagnetic radiation from the electromagnetic radiation source through a lens before the electromagnetic radiation contacts the target sample. Passing the electromagnetic radiation through a lens may facilitate focusing the electromagnetic radiation on the surface of the target sample. In certain near-field embodiments of the LIBS device, the directing includes passing the laser through an optical fiber probe as described above. For example, the method associated with near-field devices may include passing the electromagnetic radiation from the electromagnetic radiation source through an optical fiber before the electromagnetic radiation contacts the target sample. Passing the electromagnetic radiation through an optical fiber may facilitate directing the electromagnetic radiation to the surface of the target sample.

In some instances, the emissions produced when the laser beam contacts the target sample include atomic emission spectra from the plasma. In certain embodiments, the evaluating includes detecting the atomic emission spectra from the plasma. The detecting may be performed by a detector as described above. In some cases, the detector detects emissions from the plasma and produces data that represents the detected emissions. For instance, the data may be atomic emissions spectra data that corresponds to the atomic spectra emissions from the plasma.

In certain embodiments, the ablating also produces ablated material at the ablation site. For example, the ablated material may be produced when the electromagnetic radiation contacts the target sample. Ablated material may include material from the ablation site that is ejected from the ablation site during the ablating, such as remnants of the plasma produced at the ablation site. In some cases, the method further includes evaluating the ablated material with a second device configured to characterize the ablated material. For example, the second device may be a LIBS device, a mass spectrometer, a Raman spectrometer, a fluorescence spectrometer, a laser induced fluorescence spectrometer, an x-ray fluorescence spectrometer, and the like. Additional devices as described above may be included upstream or downstream from the subject LIBS device as desired.

In certain embodiments, the method includes contacting a first laser beam with a target sample to produce a plasma and an ablation site. The method may further include contacting a second laser beam with the plasma. In these cases, contacting the second laser beam with the plasma may facilitate an increase in the plasma strength and emission, thus facilitating detection of the emission spectra and may increase the signal-to-noise ratio.

### Utility

The subject devices and methods find use in a variety of different applications where it is desirable determine whether an element is present in a target sample. The high-spatial resolution of the subject devices and methods find use in performing submicron and nanoscale chemical analysis of materials. The subject devices and methods find use in many applications, such as but not limited to the detection of energetic materials, biological specimens, including biological hazardous specimens, as well as in diagnostics for the electronics industry (e.g. composition of nanostructures, contaminants, etc.), and the like.

The subject devices and methods find use in diagnostics instruments for electronics manufacturing. For example, the subject devices and methods can be used to detect the composition of nanostructures, such as, but not limited to, microelectromechanical systems (MEMS). The subject devices can be configured to scan across the surface of a target sample and analyze the target sample at various intervals across the surface of the target sample. The device may detect the presence or absence of an element at various positions on the target. As such, the subject devices and methods may be used to detect the composition of a nanostructure at various positions on the nanostructure. The detected composition of the nanostructure at the various positions can be compared to the desired composition of the nanostructure at the corresponding positions to determine if the nanostructure was formed as desired.

In addition, the subject devices and methods find use in detecting impurities in electronic components. For example, the subject devices and methods can be used to detect and quantify elements such as, but not limited to, lead, cadmium, mercury, chromium, and bromine. The subject devices and methods may be used as part of quality control measures to determine compliance with regulations limiting the use of certain substances in electronics manufacturing, such as but not limited to the Restriction on Hazardous Substances (RoHS) and the Waste Electrical Electronic and Equipment (WEEE) directives. For example, the subject devices and methods find use in detecting banned or restricted elements in: leadframes; Fine Ball Grid Array (FBGA) packages; circuit boards; individual passive components; electrical wires; plastic housings; plastic molds; other thermoplastics, including polyethylene, polypropylene, and polyvinyl chloride (PVC); and the like. The subject devices and methods may also find use in identifying the composition of thin materials, such as thin wires and thin-plating materials, where it is desirable to minimize interference from the underlying substrate.

The subject devices and methods also find use in the analysis of raw quartz material and solar silicon feedstock for producing solar cells. For example, the subject devices and methods may be used in the manufacturing process for crystalline solar silicon (c-Si) to detect elemental impurities, such as Fe, Al, Ca, Ti, Ni, Cu, Cr, B, P, etc. In some instances, monitoring the impurity levels in raw quartz and silicon feedstock materials facilitates more efficient purification process and frequency, and lowers energy usage and manufacturing costs.

In some cases, the subject devices and methods find use in the analysis of works of art. For example, the subject devices and methods can be used to analyze the elemental composition of materials used to make the work of art, such as but not limited to paint, metal, glass, stone, ceramic, and the like. The detected elemental composition of the work of art may be used to determine the age of the work of art, the authenticity of the work of art, etc. Because, in certain embodiments, the subject devices and methods are configured to produce ablation sites with very small average diameters as described above, the subject devices and methods may facilitate analysis of works of art by allowing very small sample sizes to be analyzed, such that the amount of material removed from the work of art during analysis is minimized.

As can be appreciated from the disclosure provided above, the present disclosure has a wide variety of applications. Accordingly, the following examples are offered for illustration purposes and are not intended to be construed as a limitation on the invention in any way. Those of skill in the art will readily recognize a variety of noncritical parameters that could be changed or modified to yield essentially similar results. Thus, the following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric.

### EXAMPLES

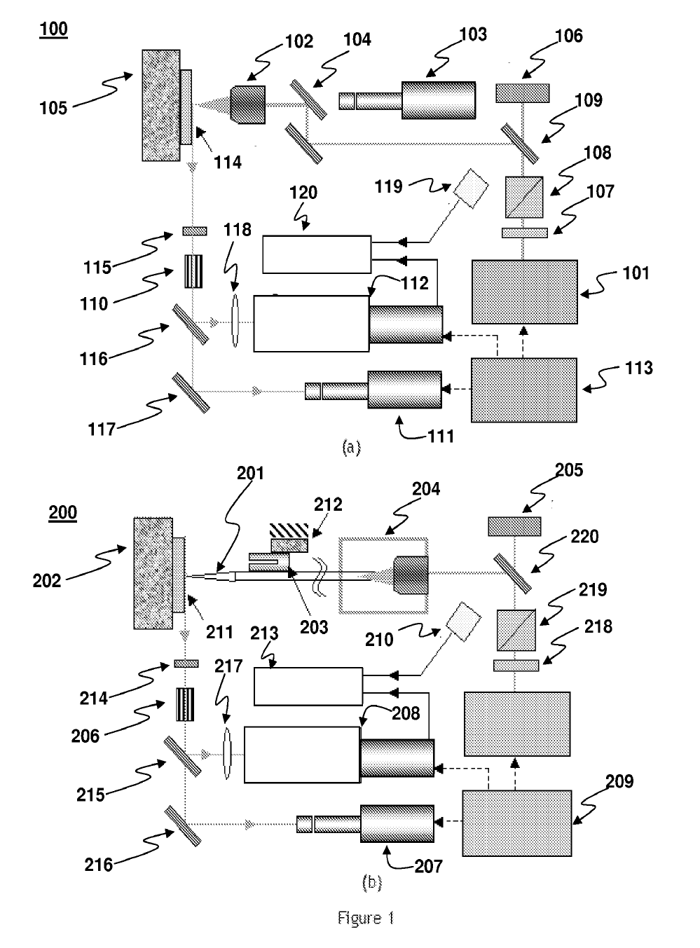

FIG. 1(a) shows a schematic diagram of the objective lens based (i.e., optical far-field) ablation and plasma emission measurement device 100. Laser pulses of 532 nm wavelength and 4 ns to 6 ns temporal pulse width from a nanosecond laser 101 (Q-switched Nd:YAG, New Wave Research, Fremont, Calif.) were focused through an objective lens 102. Two different objective lenses with numerical aperture (NA) values of 0.14 and 0.7 were tested, thereby achieving laser focal spot diameters of 7 μm and 1.5 μm, respectively. The same objective lenses were used for in-situ monitoring of the target sample surface by a white light source and via a zoom lens (12×), a charge-coupled device (CCD) camera 103 and a cathode ray tube (CRT) monitor (not pictured). The white light beam was combined with the laser beam by a dichroic mirror (DM) 104. The acquired in-situ surface image provided a useful means for adjusting the exact focal length of the objective on the target sample surface. In-situ image of the sample was kept sharp during the translation of the sample at broad range of the sample (5 mm in both x and y directions). A fresh sample target area was provided by an XYZ motorized micro-stage 105 for each single laser pulse as all the measured data were obtained from single laser pulses. The laser pulse energy was measured by an energy meter 106 (J5-09, Coherent-Molectron Inc., Santa Clara, Calif.). In order to precisely control the laser pulse energy, an attenuator set that included a half waveplate (I/2) 107 and a polarizing beamsplitter (PBS) 108 was inserted in the laser path and hence the laser beam applied to the sample surface was linearly polarized (P, polarized). A beam splitter 109 directed a portion of the laser to the energy meter 106 and a portion of the laser on an optical path towards the objective lens 102. In order to minimize the polarization effect of the pump beam, the target sample was precisely aligned normal to the laser beam by adjusting the tilting angle of the target sample. Measurements were obtained in ambient air environment by single laser shots.

A side-view microscope system was employed to collect plasma emission via an objective lens 110 (10×, Olympus, LMPIanFI). The collected light was first passed through a filter 115 and then through the objective lens 110. The collected light was split by a beam splitter 116. A portion of the collected light from the beam splitter 116 was reflected off of mirror 117 and delivered to an Intensified Charge Coupled Device (ICCD) camera 111 connected through a 12× zoom lens for time-resolved emission imaging. For the time-resolved spectrum measurement, a portion of the collected light from beam splitter 116 was re-focused using collecting lens 118 onto a single fiber bundle directly connected to the slit entrance of a spectrometer/ICCD camera system 112 (Princeton Instruments, Trenton, N.J.) of 2 ns minimum gate width. A delay generator 113 (DG535, Stanford Research Systems, Sunnyvale, Calif.) was utilized to control the gate opening of the ICCD camera 111 relative to the laser firing. A silicon detector 119 connected to an oscilloscope 120 captured the actual laser pulse timing. Processing nanosecond pulsed laser spot on the sample was collected by the ICCD at reduced level in order to establish alignment of the collection optical path and also define the origin of time. The time-zero was set at the peak intensity of the temporally Gaussian-shaped nanosecond laser pulse. A 200 nm thick Cr target sample 114 was used. Cr has strong transition line peaks in the visible spectral region. The 200 nm thick Cr film was deposited on a quartz wafer by thermal evaporation. Ablated craters were scanned with AFM for characterization of the feature topography.

FIG. 1(b) shows a schematic diagram of the optical near-field based ablation and plasma emission measurement device 200. The optical near-field fiber probe 201 was fabricated by a pulling method and a dielectric probe was utilized to achieve efficient light transmission and higher probe damage threshold. The pulling parameters were set to obtain tip diameter of 300 nm with a single mode fiber in the near-infrared range. A three-dimensional XYZ-piezo stage 202 provided precise control of the probe-sample gap distance with feedback signal from a laterally vibrating tuning fork 203 connected to a piezo element 212. For the optical near-field ablation experiments, nanosecond pulses of 532 nm wavelength and 4 ns to 6 ns pulse width were coupled to the pulled probe via a fiber coupler 204. For measuring the pulse energy emitted from the fiber probe, two Joule meters were used to monitor both the coupled laser pulse energy and the output emerging from the probe apex. The energy meter 205 measuring the coupled laser pulse energy is shown. In order to precisely control the laser pulse energy, an attenuator set that included a half waveplate (I/2) 218 and a polarizing beamsplitter (PBS) 219 was inserted in the laser path and hence the laser beam applied to the sample surface was linearly polarized (P, polarized). A beam splitter 220 directed a portion of the laser to the energy meter 205 and a portion of the laser on an optical path to the fiber coupler 204.

A side-view microscope system was employed to collect plasma emission via an objective lens 206 (10×, Olympus, LMPIanFI). The collected light was first passed through a filter 214 and then through the objective lens 206. The collected light was split by a beam splitter 215. A portion of the collected light was reflected off of mirror 216 and delivered to an Intensified Charge Coupled Device (ICCD) camera 207 connected through a 12× zoom lens for time-resolved emission imaging. For the time-resolved spectrum measurement, a portion of the collected light from beam splitter 215 was re-focused using a collecting lens 217 onto a single fiber bundle directly connected to the slit entrance of a spectrometer/ICCD camera system 208 (Princeton Instruments, Trenton, N.J.) of 2 ns minimum gate width. A delay generator 209 (DG535, Stanford Research Systems, Sunnyvale, Calif.) was utilized to control the gate opening of the ICCD camera 207 relative to the laser firing. A silicon detector 210 connected to an oscilloscope 213 captured the actual laser pulse timing. Processing nanosecond pulsed laser spot on the sample was collected by the ICCD at reduced level in order to establish alignment of the collection optical path and also define the origin of time. The time-zero was set at the peak intensity of the temporally Gaussian-shaped nanosecond laser pulse. A 200 nm thick Cr target sample 211 was used. Cr has strong transition line peaks in the visible spectral region. The 200 nm thick Cr film was deposited on a quartz wafer by thermal evaporation. Ablated craters were scanned with AFM for characterization of the feature topography.

A schematic diagram of the device 300 for femtosecond LIBS is shown in FIG. 1(c). A femtosecond laser 301 (Spitfire, Spectra Physics Inc., Mountain View, Calif.) was used. The output from the laser was passed through a non-linear crystal 309 which doubled the frequency of the input beam. Frequency doubled (400 nm wavelength) femtosecond laser pulses of 100 fs full-width at half maximum (FWHM) temporal width were tightly focused through the objective lens 302 (numerical aperture of 0.55) to a Cr thin film sample 303, thereby achieving laser focal spot diameters of 1.5 μm. In order to precisely control the laser pulse energy, an attenuator set that included a half waveplate (I/2) 310 and a polarizing beamsplitter (PBS) 311 was inserted in the laser path and hence the laser beam applied to the sample surface was linearly polarized (P, polarized). A beam splitter 312 directed a portion of the laser to the energy meter 313 and a portion of the laser on an optical path to the objective lens 302.

The same objective lenses were used for in-situ monitoring of the target sample surface by a white light source and via a zoom lens (12×), a charge-coupled device (CCD) camera 314 and a cathode ray tube (CRT) monitor (not pictured). The white light beam was combined with the laser beam by a dichroic mirror (DM) 315. The acquired in-situ surface image provided a useful means for adjusting the exact focal length of the objective on the target sample surface. In-situ image of the sample was kept sharp during the translation of the sample at broad range of the sample (5 mm in both x and y directions). A fresh sample target area was provided by an XYZ motorized micro-stage 316 for each single laser pulse as all the measured data were obtained from single laser pulses.

A side-view microscope system was employed to collect plasma emission via an objective lens 304 (10×, Olympus, LMPIanFI). The collected light was first passed through a filter 317 and then through the objective lens 304. The collected light was split by a beam splitter 318. A portion of the collected light from beam splitter 318 was reflected off of mirror 319 and delivered to an Intensified Charge Coupled Device (ICCD) camera 305 connected through a 12× zoom lens for time-resolved emission imaging. For the time-resolved spectrum measurement, a portion of the collected light from beam splitter 318 was re-focused using a collecting lens 320 onto a single fiber bundle directly connected to the slit entrance of a spectrometer/ICCD camera system 306 (Princeton Instruments, Trenton, N.J.) of 2 ns minimum gate width. A delay generator 307 (DG535, Stanford Research Systems, Sunnyvale, Calif.) was utilized to control the gate opening of the ICCD camera 305 relative to the laser firing. A silicon detector 308 connected to an oscilloscope 321 captured the actual laser pulse timing. Processing nanosecond pulsed laser spot on the sample was collected by the ICCD at reduced level in order to establish alignment of the collection optical path and also define the origin of time. The time-zero was set at the peak intensity of the temporally Gaussian-shaped nanosecond laser pulse. A 200 nm thick Cr target sample 303 was used. Cr has strong transition line peaks in the visible spectral region. The 200 nm thick Cr film was deposited on a quartz wafer by thermal evaporation. Ablated craters were scanned with AFM for characterization of the feature topography.

### Far-Field Femtosecond LIBS

Frequency doubled (400 nm wavelength) femtosecond laser pulses were focused through objective lenses onto a Cr thin film coated on quartz wafer, in order to obtain ablation craters of sub-micron lateral dimensions. Side view time-resolved emission images and the corresponding spectra showed the detailed plasma evolution at the fluence range near the ablation threshold. The collected emission spectra at the laser fluence level of about 2-3 times the ablation threshold showed characteristic atomic transition peaks of the ablated Cr material from sub-micron ablation craters.

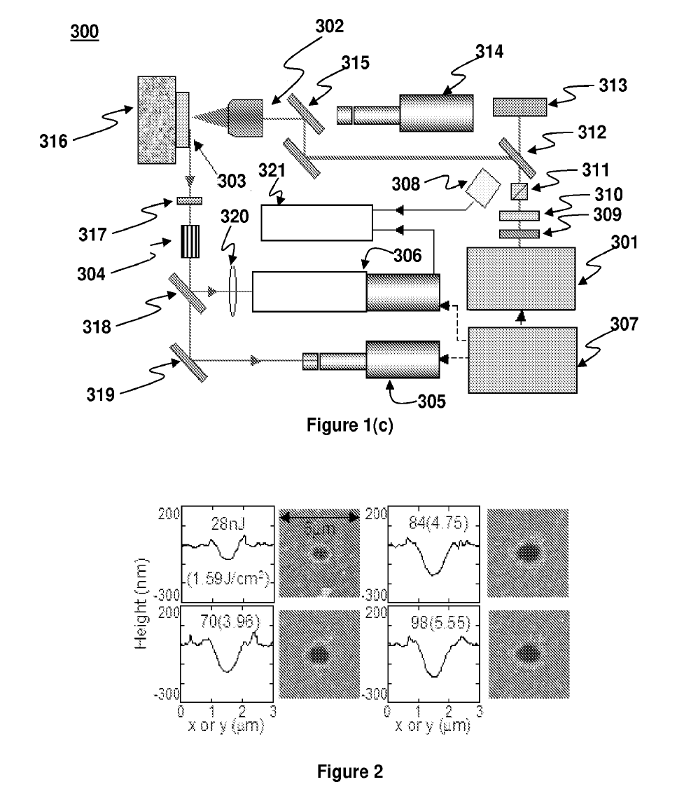

FIG. 2 shows AFM scanning images of ablation craters for different laser pulse energies. Craters were obtained with average diameters of 470 nm at FWHM and 76 nm in depth with pulse energy of 28 nJ (which corresponds to a laser fluence of 1.59 J/cm²). Both the average diameter and depth of the craters increased with increasing laser fluence with the crater depth approaching the film thickness of 200 nm at a pulse energy of 126 nJ (7.92 J/cm²) (data not shown).

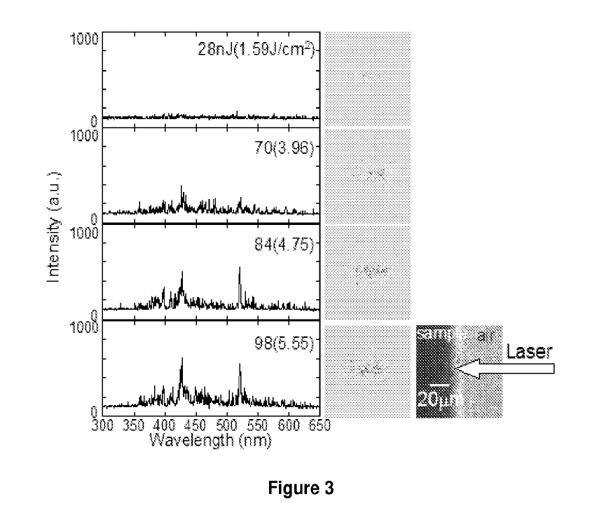

Side-view images of the ablation plume expansion collected over the entire plasma lifetime (gate width of 1 ms), are shown in FIG. 3 on the right side of the corresponding spectra. The emission was due to transition of highly excited electrons to lower electronic energy states in the transient ablation process. The collected images showed material ejecta over the entire plasma lifetime. The emission was just visible near the ablation threshold. When the fluence level exceeded 4 J/cm², the emission was composed of several parts: a small bright spot near the laser focus on the sample, directional material expulsion marked by high emission intensity that was encompassed by widely spread ejecta whose emission was less intense.

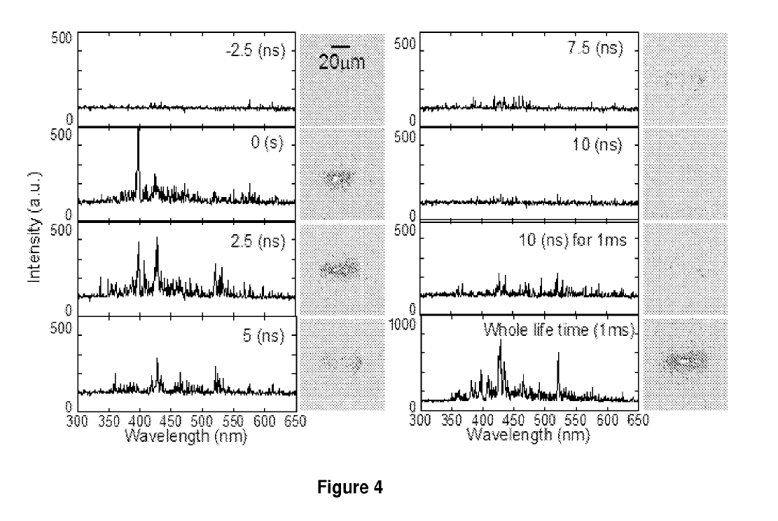

Measured spectra (collected over the entire lifetime) are shown in FIG. 4 on the left side of each fluence case. The spectrum near 400 nm was due to small leakage from the processing femtosecond laser beam. Near the ablation threshold, the collected emission signal showed a random and broad spectrum. However, when the fluence reached 3 J/cm² to 5 J/cm², discrete peaks appeared in the measured spectrum. Peaks were observed near 357-360 nm, 425-429 nm, and 520 nm, corresponding to Cr spectral lines from electronic transitions. Hence, the measured spectra displayed LIBS signal of Cr. The LIBS detection threshold was therefore observed at 2-3 times the ablation threshold with corresponding ablation crater FWHM average diameter of 650 nm and depth of 150 nm. Less conductive and non-absorbing samples may yield tighter spatial resolution due to reduced electrical/thermal diffusion and effectively tighter focusing by non-linear multi-photon absorption.

Acquired spectra and emission imaging with 2 ns time resolution for the laser fluence of 5.55 J/cm² case, that is 1.3 times fluence of LIBS threshold, are shown in FIG. 4. At time zero (over a 2 ns period before and after the femtosecond laser pulse reaches the sample), an intensely bright spot was seen near the laser focal volume on the target sample. According to the measured spectrum at time zero, a portion of the bright light near the laser focus was attributed to leakage of the processing laser (of 400 nm wavelength). However, other broad-spectrum components captured the early stage plasma expansion at 10⁴ m/s average velocity. At t=2.5 ns, the material plasma plume expanded preferentially along the sample outward normal direction. The intensities of the LIBS lines reach maxima at 2.5 ns after the termination of the laser pulse rather than at time zero that corresponds to the peak laser intensity. This trend indicated that collision of the expanding plasma with surrounding gas molecules was the mechanism of the subsequent plasma excitation. Since material ejection commences in the time frame of 10's to 100's ps after the laser illumination, interaction of the laser pulse with the material ejecta via Inverse Bremsstrahlung and/or photoionization processes does not occur for the laser pulse of 100 fs temporal width, hence minimizing the wide-spectrum background emission as shown in the time-resolved spectra. At t=5 ns, the bright spot near the laser focal volume was not detectable. The remaining ejecta collided with environmental gas molecules, producing LIBS signals that decayed rapidly afterwards. However, the collected emission signal for the remaining lifetime period carry LIBS contributions, as shown in the spectrum measured at t=10 ns for 1 ms (FIG. 4). Considering the ablated volume and plasma evolution trend, the ablation material plume from sub-micron craters was expected to contain abundant small particles. Furthermore, the one-dimensional plume expansion should facilitate particle collection and delivery to downstream instruments such as mass spectrometers for subsequent chemical species analysis at high spatial resolution. The orders of magnitude lower shorter life time of the ablation-induced plasma was mainly attributed to smaller ablation volume and the near the ablation threshold fluence. The time-resolved spectrum measurement (FIG. 4) showed that the observed LIBS signal-to-background emission ratio was achieved by collecting over the entire lifetime.

Characteristics of the subject femtosecond laser-induced plasma in tight focusing configuration are summarized as follows: (1) the ultrashort pulse laser ablation contributed to the shorter life time of the ablation-induced plasma through minimizing the ablation crater volume, (2) no plasma reheating mechanism was observed but the ultrashort laser pulse led to a higher degree of excitation within a confined sample volume, thereby providing sufficient momentum for collision dominated breakdown process, and (3) improved LIBS signal to background emission ratio was observed.

### Optical Near-Field LIBS

The evolution of optical near-field ablation induced plasma was visualized with dielectric NSOM probe design and green nanosecond laser pulses (532 nm wavelength) applied onto metallic thin film samples.

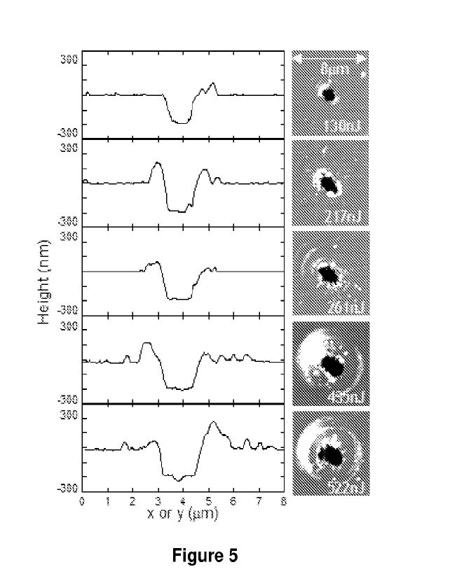

FIG. 5 shows AFM scanning images of ablation craters produced by an optical near-field fiber probe under various coupled pulse energy conditions. Ablation craters 800 nm in average diameter were observed, while the entire film thickness of 200 nm was removed by applying pulse energy of approximately 130 nJ. Since the estimated beam spot size by optical field simulation was approximately 300 nm (data not shown), the minimum crater size suggested an effective order of diffusion length of 200 nm through the Cr film. The laser spot size being close to the thermal diffusion length scale leads to orders of magnitude higher ablation threshold, as the estimated ablation threshold in the current optical near-field experiment was higher than 100 J/cm².

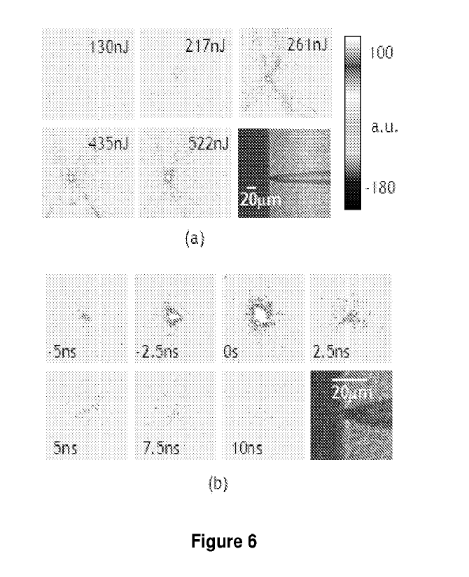

Streak images of ejecta collected over the entire plasma lifetime (gate width of 10 μs) are shown in FIG. 6(a). The emission was just visible at pulse energy level of 130 nJ that was close to the ablation threshold but the intensity increased thereafter as the laser pulse energy increased. The symmetric traces towards the left were mirror reflections of the ablation-induced emission off the sample surface. The emission included a bright spot that appeared near the probe-sample gap and the jet-like material expulsion away from the gap region and around the probe tip in a conical fashion. As shown in the time-resolved imaging shown in FIG. 6(b), the bright emission near the gap evolved almost synchronized with the laser pulse and very rapidly dispersed away from the sample-probe gap. The particle streaklines indicated that most of the ablated material escaped from the nanoscale gap region. The jet-like expulsion may facilitate particle collection and delivery to downstream instruments such as mass spectrometers for subsequent chemical species analysis.

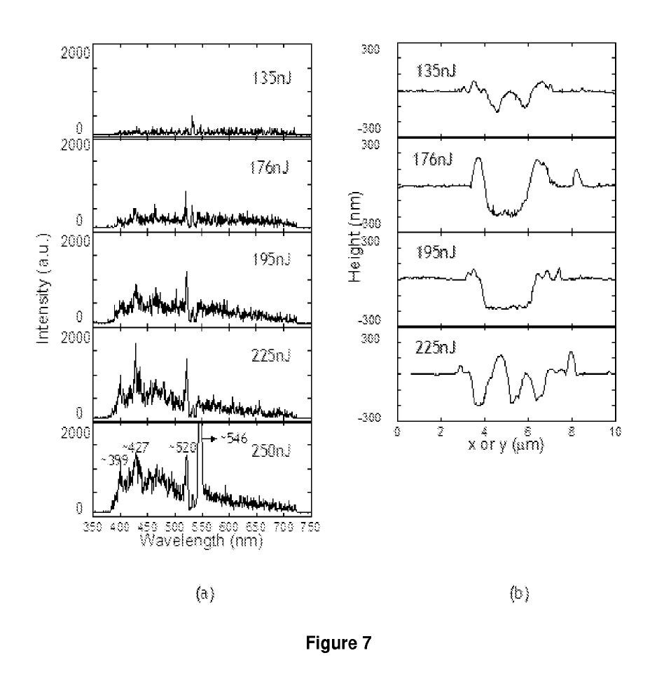

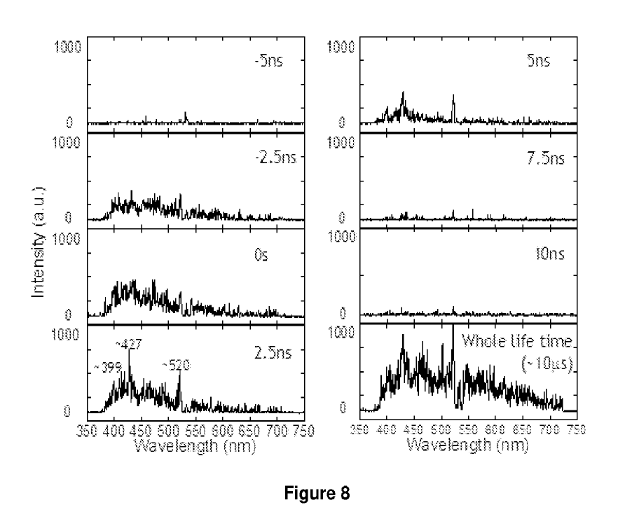

Time-resolved spectra were also measured and compared with the ablation craters as shown in FIG. 7. The spectrum of the emission light was first collected over the entire lifetime as shown in FIG. 7(a). Near the ablation threshold (at 135 nJ), the emission signal was detectable, showing a random, broad spectrum. As the laser pulse energy increased, Cr LIBS peaks appeared in the measured spectrum. The additional peak near 546 nm corresponded to Si, which indicates possible damage of the fiber probe tip. The latter was corroborated by observation of the same peak when the tip was raised far from the specimen surface, confirming that the peak was not from Si composition in the quartz substrate. Time-resolved, spectral emission measurement with 2 ns temporal resolution is shown in FIG. 8 for 195 nJ pulse energy. The emission evolved in concert with the processing laser pulse and rapidly decayed after its termination. This signal exhibited a similar trend with that of the bright spot emission near the probe-sample gap as shown before in FIG. 6(b), with respect to intensity and lifetime. Therefore, the bright spot near the gap traced a plasma state that appeared in the early stage of laser illumination and then rapidly decayed.

The plasma behavior in the optical near-field ablation was due to the presence of the sharp probe structure in the vicinity of the sample. The probe tip apex was maintained at distance of 10 nm from the surface of the target sample. Statistically, few electrons and ejected matter volume are present in the region between the optical probe tip and the surface of the target sample, and sparse collisional events occur in this region. Furthermore, the probe was, in effect, a physical obstacle introducing a virtually infinite resistance to the expanding plume in an outward direction normal to the surface of the target sample. Therefore, most ejected matter tended to quickly move away from the region between the optical probe tip and the surface of the target sample and experienced collisions with background gas molecules as shown in FIG. 6. Considering the small laser illumination volume defined by the region between the optical probe tip and the target sample in comparison to the relatively larger scale of ablation plume expansion within the nanosecond laser pulse duration, the laser coupling into the ablated plasma and the resulting reheating were minimal in the near-field configuration. The reduced plume-laser interaction in the optical near-field ablation configuration facilitated the production of stable ablation features. In addition, an improved signal-to-noise ratio in the optical near-field LIBS scheme was observed.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A laser induced breakdown spectroscopy device configured to obtain a spatial resolution of 10 μm or less.

2. The device of claim 1, wherein the device is configured to obtain a spatial resolution of 5 μm or less.

3. The device of claim 1, wherein the device comprises:
an ablator configured to produce a plasma and an ablation site having an average diameter of 10 μm or less on a surface of a target sample; and
a detector.

4. The device of claim 3, wherein the ablation site has an average diameter ranging from 0.1 μm to 7 μm.

5. The device of claim 3, wherein the ablation site has an average diameter ranging from 0.1 μm to 3 μm.

6. The device of claim 3, wherein the ablation site has an average diameter ranging from 0.05 μm to 1 μm.

7. The device of claim 3, wherein the ablator comprises a nanosecond laser.

8. The device of claim 7, wherein the nanosecond laser has a pulse width ranging from 4 ns to 6 ns.

9. The device of claim 3, wherein the ablator comprises a femtosecond laser.

10. The device of claim 9, wherein the femtosecond laser has a pulse width ranging from 10 fs to 150 fs.

11. The device of claim 3, wherein the ablator is configured to emit electromagnetic radiation having a wavelength ranging from 380 nm to 800 nm.

12. The device of claim 3, wherein the ablator is configured to emit electromagnetic radiation having a wavelength ranging from 10 nm to 380 nm.

13. The device of claim 3, wherein the ablator comprises a laser and a lens.

14. The device of claim 13, wherein the lens has a numerical aperture ranging from 0.1 to 1.

15. The device of claim 3, wherein the ablator comprises a laser and an optical probe.

16. The device of claim 15, wherein the optical probe comprises an optical fiber probe.

17. The device of claim 3, wherein the detector is configured to detect emissions from the plasma at an angle of 90 degrees or less with respect to the surface of the target sample.

18. A method for determining whether an element is present in a target sample, the method comprising:
ablating the target sample with an ablator configured to obtain a spatial resolution of 10 μm or less to produce a plasma and an ablation site on a surface of the target sample; and
evaluating the plasma to determine whether the element is present in the target sample.

19. The method of claim 18, wherein the ablating comprises contacting the target sample with electromagnetic radiation emitted from the ablator.

20. The method of claim 18, wherein the ablation site has an average diameter of 10 μm or less.

21. The method of claim 18, wherein the plasma is evaluated by detecting atomic emission spectra from the plasma.

22. The method of claim 19, wherein the method comprises passing the electromagnetic radiation through a lens before the contacting.

23. The method of claim 19, wherein the method comprises passing the electromagnetic radiation through an optical probe before the contacting.

24. The method of claim 18, wherein the ablating produces ablated material.

25. The method of claim 14, wherein the method comprises evaluating the ablated material with a second device configured to characterize the ablated material.

26. The method of claim 18, wherein the method comprises contacting the plasma with electromagnetic radiation.
